(19) United States
(12) Patent Application Publication
(10) Pub. No.: US 2023/0400749 A1
(43) Pub. Date: Dec. 14, 2023

(54) Lens Cap

(71) Applicant: Jeffrey Overall, Costa Mesa, CA (US)

(72) Inventor: Esteban Martinez, Fountain Valley, CA (US)

(73) Assignee: Polar Pro Filters, Inc., Costa Mesa, CA (US)

(21) Appl. No.: 17/835,682

(22) Filed: Jun. 8, 2022

(51) Int. Cl. G03B 11/04; G02B 7/00

(52) U.S. Cl. CPC G03B 11/041; G02B 7/006

(57) ABSTRACT

A lens cap enabling attachment of two modular plate components with a camera filter. The plate components enabling protection of the glass aspect of the filter when the filter is both, coupled with a camera, and when it is detached.

### FIELD OF INVENTION

The present invention relates to the storage of a camera filter. Specifically, it relates to a lens cap utilizing a push button system, rotation locking, and magnetism to couple modular components to a camera filter.

### SUMMARY

A front plate, a back plate, and filter comprise the modular components of the lens cap system. The front plate and the back plate can couple the filter individually and simultaneously. A rotation locking system may provide a first means of coupling. The back plate is intended to couple with the surface of the filter configured to couple with a camera or other auxiliary device.

A tooth or teeth may extend from an inner planar surface of both the front plate and the filter. The tooth (teeth) may be configured to be inserted into a filter cavity (cavities) aspect of the filter's frame.

The front plate may then be rotated within to operatively couple the front plate with the filter, protecting the filter glass from contact when it is coupled with a camera. “Operative coupling” may be used herein to mean attachment of the components while still allowing movement of the components relative to each other.

A similar coupling system may be used to couple the filter and the back plate. A tooth or teeth may extend from an inner surface of a frame. The tooth (teeth) may be configured to be inserted into a back plate cavity (cavities) aspect of the back plate. The filter may then be rotated within to operatively couple the front plate with the filter.

Any of the three aspects may comprise a push button lock. In an exemplary embodiment, the front plate and filter may comprise a push button lock. Each push button lock may comprise a biasing device that urges a push button hook into a lock position. When of the front plate, or filter, are inserted into their corresponding cavity, the push button hook may engage a surface of the filter, or back plate, respective, forcing the push button out of the lock position. The component is then rotated until the push button hook aligns with the hook socket and the biasing device urges the push button hook into the socket, thereby coupling the two components stationary relative to each other.

Each push button lock may comprise a push button actuator. The push button actuator is engaged to exert force on the push button hook, moving it out of the locked position and enabling the detachment of the components.

### BRIEF DESCRIPTION OF DRAWINGS

FIG. 1 is a perspective view of a front plate, filter, and back plate uncoupled.

FIG. 2A is a perspective view of a front plate and filter in a protective position, and a back plate and a filter in a case position.

FIG. 2B is a side view of a front plate and filter in a protective position, and a back plate and a filter in a case position.

FIG. 3 is a back bottom perspective view of a front plate.

FIG. 4 is a back top perspective view of a front plate with certain aspects exploded.

FIG. 5A is a front top perspective view of an isolated push button.

FIG. 5B is a front top perspective view of an exploded push button.

FIG. 6A is a left side view of a plate push button in an unlocked position.

FIG. 6B is a left side view of a plate push button in a locked position.

FIG. 7A is a back view of a filter.

FIG. 7B is a front view of a filter.

FIG. 7C is a left side view of a filter.

FIG. 8 is a back perspective view of a filter with a push button and filter back magnets exploded.

FIG. 9 is a front perspective view of a back plate.

FIG. 10 is a front plate coupled with a filter in a protective position.

FIG. 11A is a back planar view of a filter with two push buttons.

FIG. 11B is a front planar view of a filter with two push buttons.

FIG. 12 is a back planar view of a front plate with two push buttons.

### DRAWING NUMERALS

10 unlocked position
20 locked position
50 protective position
60 case position
100 filter
110 push button lock
111 push button actuator
112 button hook
116 push button hook
130 filter coupling ring
132 filter coupling tooth
140 filter back magnet
142 filter front magnet
150 filter glass
160 filter frame
162 filter rim
164 filter rim window
166 frame cavity
168 hook socket
170 front ring
172 back ring
200 front plate
220 front plate magnets
230 coupling ring
232 plate coupling tooth
220 front plate magnets
300 back plate
330 back plate rim
331 back plate rim cavity
333 push button socket
332 back plate rim window
340 back plate magnets

### DETAILED DESCRIPTION OF THE DRAWINGS

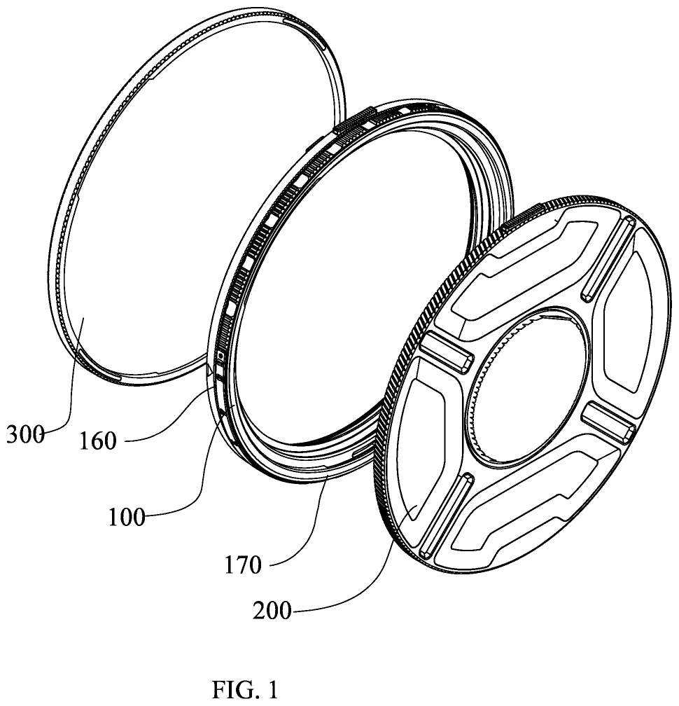

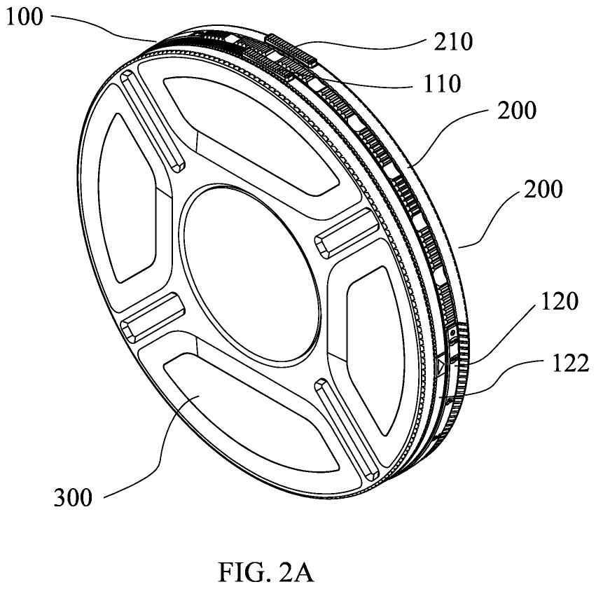

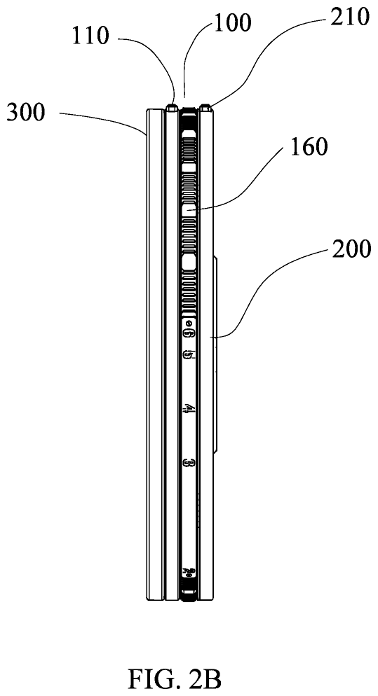

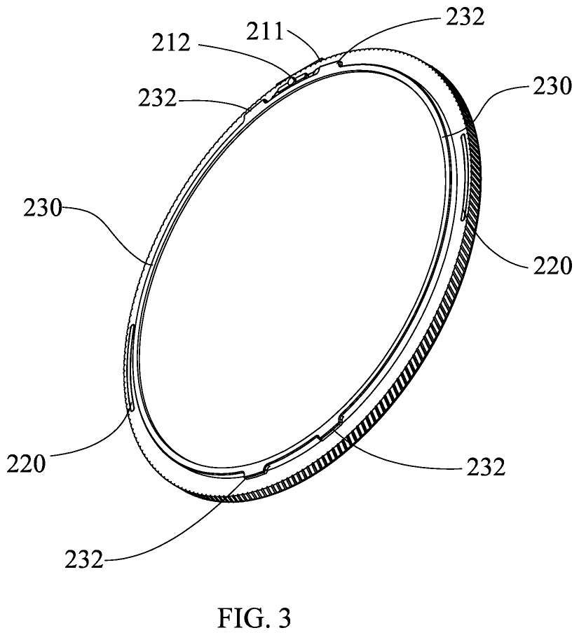

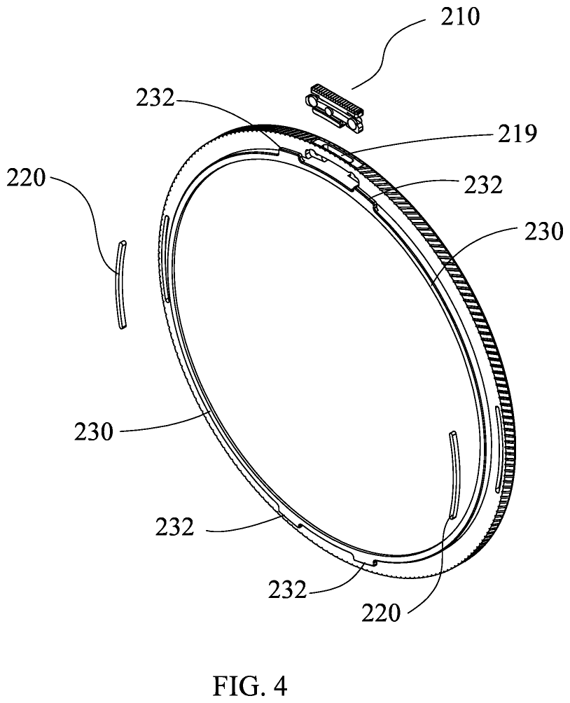

An exemplary lens cap system comprises a filter 100, a front plate 200, and a back plate 300 (See FIG. 1). A front plate 200 may be cylindrical and comprise coupling aspects on an inner planar surface (see FIGS. 3-4). A plate coupling ring 230 may be circular and protrude from the inner planar surface of front plate 200. Plate coupling teeth 232 may extend perpendicularly, toward the perimeter of the front plate 200 from the plate coupling ring 230. Front plate magnets 220 may be embedded into the perimeter of the inner planar surface of the front plate 200.

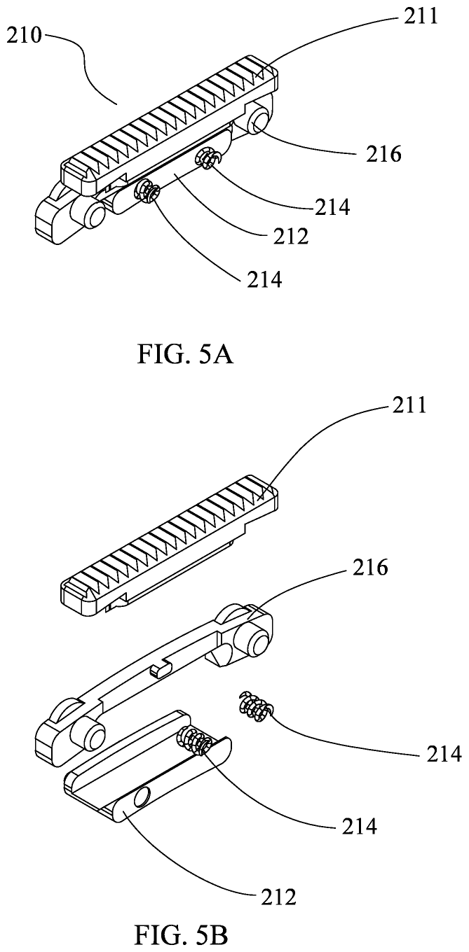

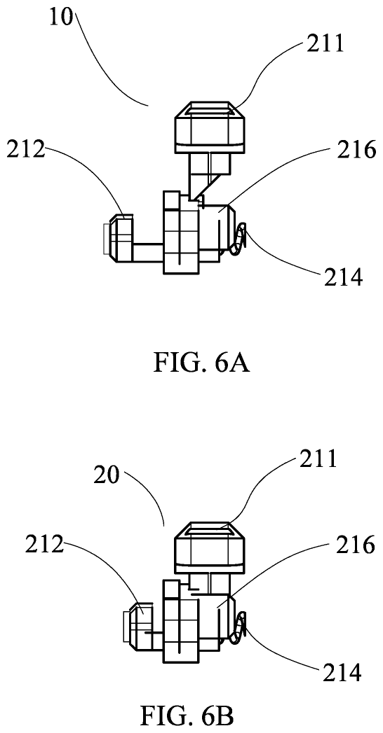

A push button lock 110 may be coupled with and/or partially housed within the front plate 200 (see FIGS. 5A-6B). A plate push button actuator 111 may extend from the outer edge of the front plate 200. The push button actuator 111 may interface with a plate button hook 112. The interfacing surfaces of the push button actuator 111 and plate button hook 112 may be beveled, so that movement of the push button actuator 211 moves the plate button hook 212 in a perpendicular or oblique direction (see FIGS. 6A-B). A push button ridge 116 may couple with the plate 200. The push button ridge 116 may operatively couple with the actuator 211 and plate button hook 212, enabling the actuator 211 and plate button hook 212 to move relative to the plate 200.

Push button springs 114 may comprise an exemplary biasing device. Push button spring(s) 114 may extend from the plate button hook 212 and abut a surface of the plate 200. The push button spring(s) 114 may urge the button hook 212 into an unlocked position 10 (see FIG. 6A-B).

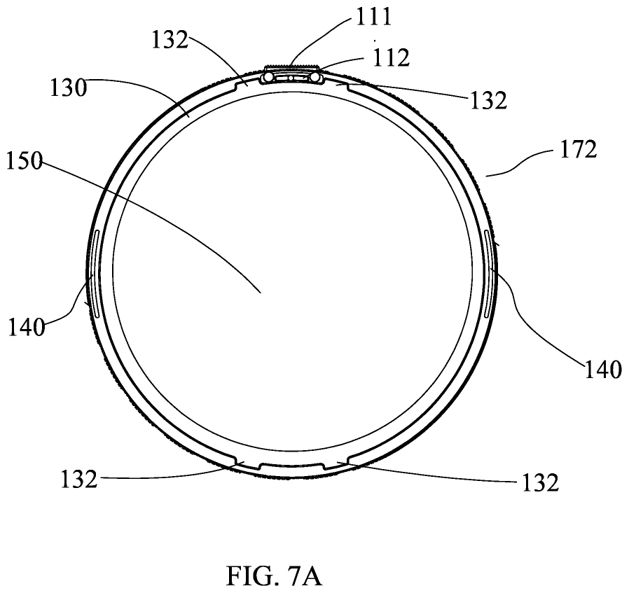

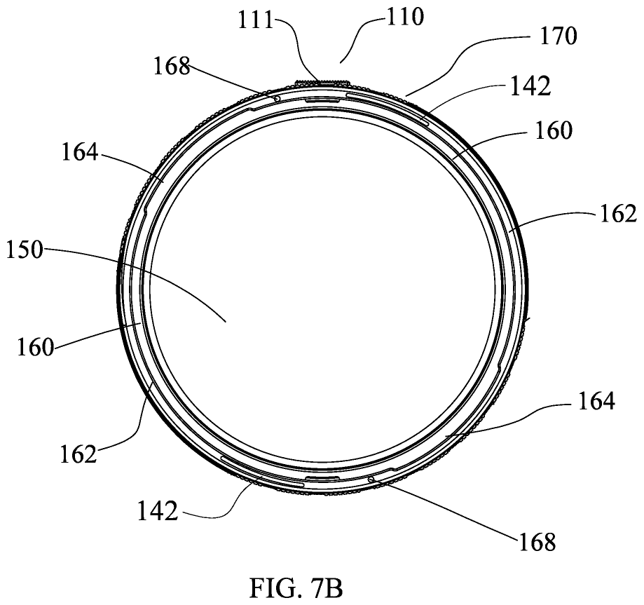

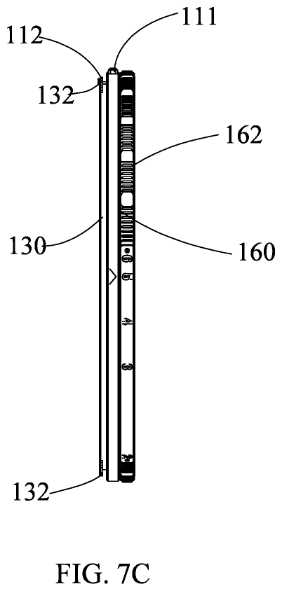

A filter 100 may comprise a filter glass 150 encased in a filter frame 160 (see FIGS. 7A-C). Front ring 170 and back ring 172 may be used herein to refer to the relative front surface and back surface of the frame 160. A filter rim 162 may extend from the front ring 170 of the frame 160. The filter 162 may create a frame cavity 166. Filter rim windows 164 may be configured to enable insertion of the plate coupling teeth 232 and rotation of the teeth into the frame cavity 166. The frame 160, or a portion thereof, maybe comprised of ferromagnetic material with the opposite polarity of the front plate magnets 220. “Opposite polarity” is used herein to mean a magnetism that exerts an attractive force on a corresponding component. The magnets (220, 142) may be configured to create an insertion position, in which the magnets (220, 142) align simultaneously with the teeth (232) align with the frame windows (164), enabling insertion.

A filter coupling ring 130 may encircle the filter glass 150 and extend from the inner surface of the back surface of the filter 100. Filter coupling teeth 132 may extend perpendicularly, toward the perimeter of the filter 100 from the filter coupling ring 130. Filter back magnet(s) 140 may be embedded or otherwise positioned on a back surface of the filter frame 160. Two hook sockets 168 may be diametrically disposed on the frame 160. Each hook socket 168 may be configured to allow insertion of a push button hook (112, 212).

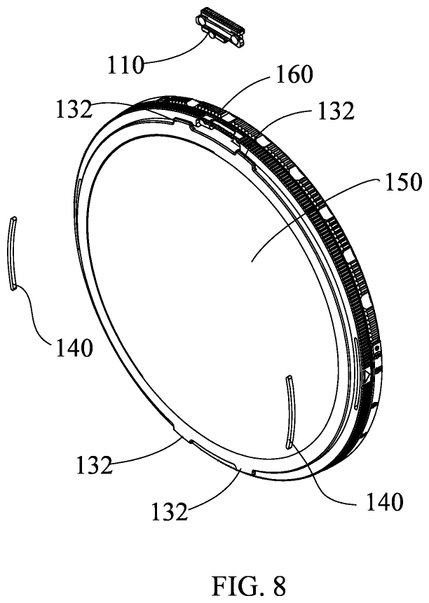

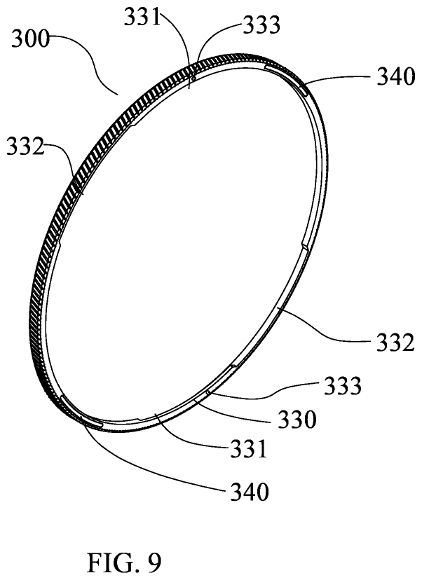

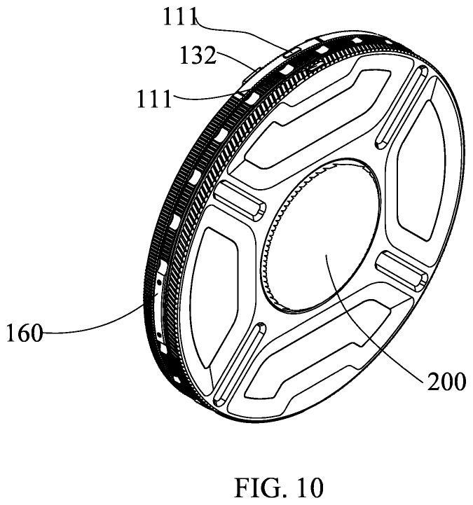

A filter push button lock 110 may be coupled with and/or partially housed within the filter 100. A filter push button actuator 111 may extend from the outer edge of the frame 160 (see FIGS. 7A-8). The push button actuator 111 may interface with a filter push button hook 112. The interfacing surfaces of the filter push button actuator 111 and filter push button hook 112 may be beveled, so that movement of the filter push button actuator 111 moves the filter push button hook 112 in a perpendicular or oblique direction. A filter push button ridge 116 may couple with the plate 100. The filter push button ridge 116 may operatively couple with the actuator 111 and button hook 112, enabling the actuator 111 and plate button hook 112 to move relative to the filter 100.

Push button spring(s) 114 may extend from the button hook 112 and abut a surface of the plate 200. The push button spring(s) 114 may urge the button hook 212 into an unlocked position 10 (see FIG. 6A-B).

A back plate 300 may comprise a back plate rim 330 extending from an inner planar surface. Back plate rim windows 332 in the rim 330 may be configured to allow insertion of the filter coupling teeth 132. Space between the back plate rim 330 and inner back planar surface of the inner planar surface of the back plate 300 may create back plate rim cavities 331. Back plate magnets 340 may be embedded into the back plate rim 330.

The front plate 200 may couple with the filter 100, creating a protective position 50. To couple the front plate 200 and filter 100, the teeth 232 are aligned with and inserted into the filter rim window 164. The teeth 232 are rotated into the frame cavity 166 until the push button 210 aligns with a hook socket 168.

The push button springs (114) may urge the plate button hook 212 into the hook socket 168, thereby coupling the components (100, 200). The back filter coupling components (130, 132) remain free to couple with a camera lens or other device. To remove the components (200, 100) from the protective position 50 an amount of force sufficient to overcome the force of the biasing device 114 is applied to the push button actuator 111 until the push button hook 112 is pushed out of the hook socket 168. The component(s) (200, 100) are then rotated until the teeth 232 and frame windows 164 rotate and the front plate 200 can be disengaged.

The back plate 300 may couple with the filter 100, creating a case orientation 60. The filter coupling teeth 132 are aligned with and inserted into the back plate rim window 332. The teeth 132 are rotated into the back plate rim cavity 331 until the push button lock 110 aligns with a hook socket 333. The push button springs (114) may urge the plate button hook 212 into the hook socket 333, thereby coupling the components (300, 100). To remove the components (300, 100) from the case position 60 an amount of force sufficient to overcome the force of the biasing device 114 is applied to the push button actuator 111 until the push button hook 112 is pushed out of the hook socket 333. The component(s) (300, 100) are then rotated until the teeth 132 and back plate rim window 332 rotate and the back plate 300 can be disengaged.

The magnets (220, 142) may be configured to create an insertion position, in which the magnets (320, 140) align simultaneously with the teeth (132) align with the back rim window (332), enabling insertion.

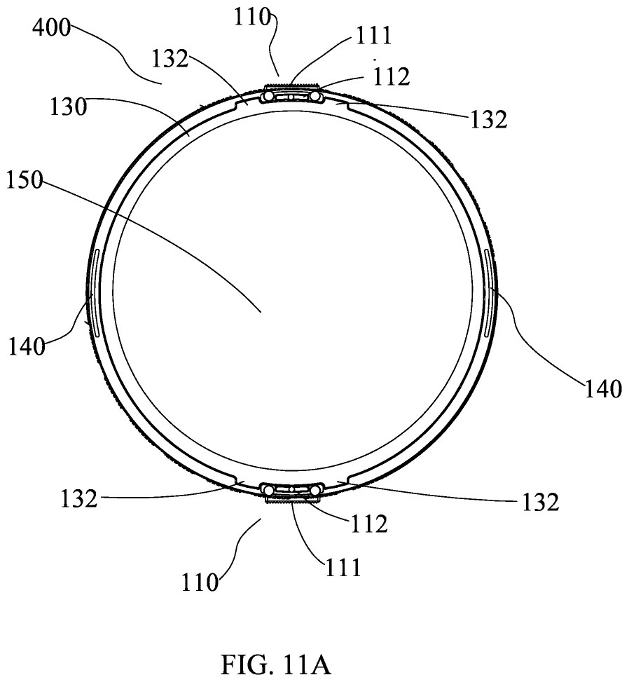

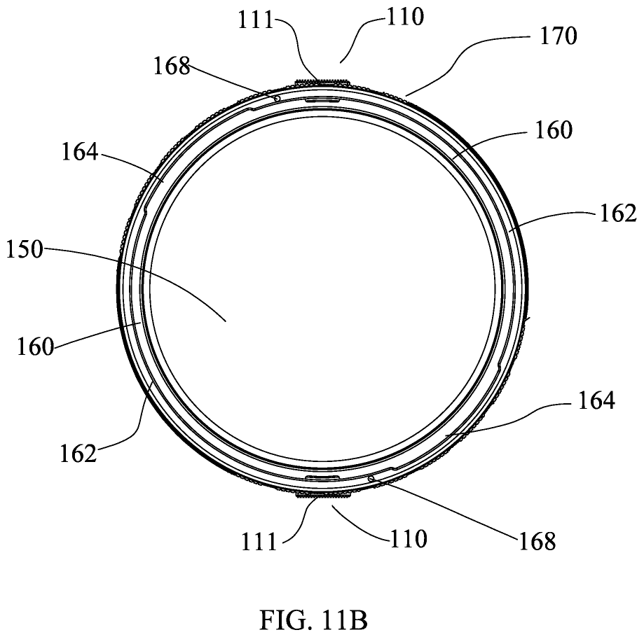

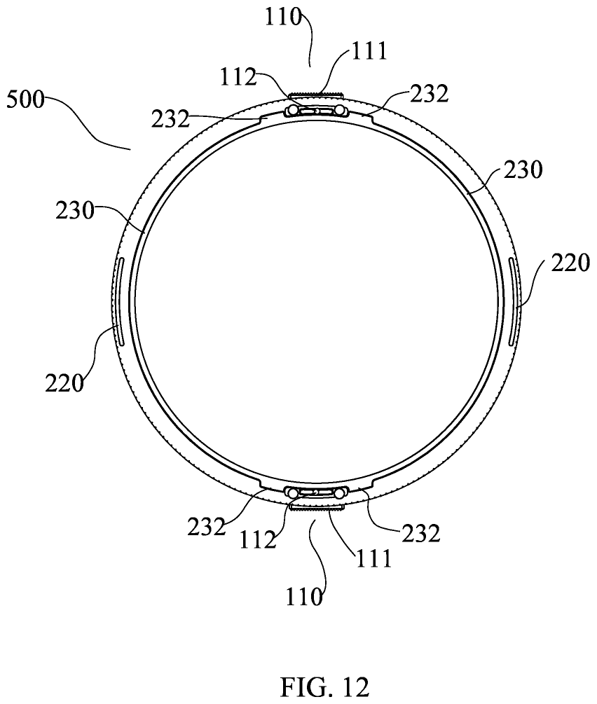

An alternative embodiment front plate 500 and filter 400 may comprise two push button locks 110 (see FIGS. 11A-B). The coupling process with the two push button embodiments (500, 400) is similar to with the one push button lock 110 embodiments (100, 200). An additional push button may enhance the coupling strength of the components in the protective position (50) and case position (60). The push button locks 110 may be diametrically opposed on the perimeter of the filter 400 and back plate 500 to be accessible in any position (50, 60, 70). Multiple push button locks 110 may make it easier for a user to locate the push button locks 110. The diametrically opposed orientation may allow the offset of manual force when a user activates the push button locks 110 simultaneously, potentially easing rotation of the teeth (132, 232) within the back plate rim cavity 331 and frame cavity 166, respectively.

Both the single push button (100, 200) and multiple push button (400, 500) embodiments may align the push button(s) with the teeth (132, 232). This orientation may ease insertion of the teeth (132, 232) into the back plate rim window(s) 332 or filter frame window 164.

The filter frame 160 and plates (200, 300) can be comprised of rigid material, such as a thermoplastic, glass filled nylon, or metal.

The foregoing disclosure is for illustration and description. Alternative embodiments may be possible in light of the above teachings. The embodiments described where chosen to explain the principles of the invention and its practical application to enable others skilled in the art to best utilize the invention. It is intended that any claims thereafter be construed to include other alternative embodiments of the invention except as limited by the prior art.

I claim:

1. A lens cap, comprising:
a. a filter, the filter comprising a frame, the frame comprising a filter magnet and a filter rim;
b. the filter rim comprising a rim window;
c. the filter further comprising a filter coupling ring, the filter coupling ring comprising a filter coupling tooth;
d. the filter further comprising a filter push button;
e. a front plate, comprising a plate magnet, the plate magnet having an opposite polarity to the filter magnet;
f. the front plate further comprising a plate coupling ring, the plate coupling ring comprising a plate coupling tooth;
g. the front plate further comprising a plate push button;
h. a back plate, the back plate comprising a plate rim, the plate rim comprising a plate rim window;
i. the plate rim further comprising back plate magnet, the back plate comprising a polarity opposite the polarity of the filter magnet;
j. the filter and front plate comprising a protective position when the plate coupling tooth is housed within the filter rim and the plate push button couples with the filter rim;
k. the filter and back plate comprising a case position when, the filter coupling tooth is housed within the plate rim and the filter push button couples with the plate rim;

2. The lens cap in claim 1, wherein the filter magnet and the front plate magnet align in an insertion position.

3. The lens cap in claim 1, wherein the filter magnet and the back plate magnet align in an insertion position.

4. A lens cap, comprising:
a. a front plate comprising a plate coupling tooth, and a plate push button;
b. the plate push button comprising a plate push button actuator, a plate push button hook, and a plate push button biasing device;
c. a filter comprising a filter socket, and a frame cavity;
d. the frame cavity being configured to enable insertion the plate coupling tooth and rotation of the plate coupling tooth within the frame cavity until the plate push button hook aligns with the filter socket and the plate push button biasing device urges the plate push button hook into the filter socket, whereby a protective position is created;
e. a back plate comprising a back plate cavity and a back plate socket;
f. the filter further comprising a filter tooth and a filter push button;
g. the filter push button comprising a filter push button actuator, a filter push button hook, and a filter push button biasing device;
h. the back plate cavity being configured to enable insertion of a filter tooth and rotation of the filter tooth within the back plate cavity until the filter push button hook aligns with the back plate socket and the filter push button biasing device urges the filter push button hook into the back plate socket, whereby a case position is created.

5. The lens cap in claim 4, wherein:
a. the front plate comprises a front plate magnet;
b. the frame comprises a front ring and a back ring;
c. the front ring comprises ferromagnetic material;
d. the front plate magnet comprises ferromagnetic material with the opposite polarity to the filter magnet, whereby the front plate and filter are attracted to each other when placed within a predetermined distance from each other;
e. the back ring comprises a filter magnet;
f. the back plate comprises a back plate magnet, the back plate magnet having a polarity opposite the filter magnet, whereby the back plate and filter are attracted to each other when placed within a predetermined distance from each other.

6. A lens cap, comprising:
a. a front plate comprising a plate coupling tooth, and a plate push button;
b. the plate push button comprising a plate push button actuator, a plate push button hook, and a plate push button biasing device;
c. a filter comprising a filter socket, and a frame cavity;
d. the frame cavity being configured to enable insertion the plate coupling tooth and rotation of the plate coupling tooth within the frame cavity until the plate push button hook aligns with the filter socket and the plate push button biasing device urges the plate push button hook into the filter socket, whereby a protective position is created;
e. a back plate comprising a back plate cavity and a back plate socket;
f. the filter push button comprising a filter push button actuator, a filter push button hook, and a filter push button biasing device;
g. the back plate cavity being configured to enable insertion of a filter tooth and rotation of the filter tooth within the back plate cavity until the filter push button hook aligns with the back plate socket and the filter push button biasing device urges the filter push button hook into the back plate socket, whereby a case position is created.

7. The lens cap in claim 6, wherein:
a. the filter comprises a filter tooth and a filter push button;
b. a back plate comprising a back plate cavity and a back plate socket;
c. the back plate cavity being configured to enable insertion of a filter tooth and rotation of the filter tooth within the back plate cavity until the filter push button hook aligns with the back plate socket and the filter push button biasing device urges the filter push button hook into the back plate socket, whereby a case position is created.

8. The lens cap in claim 6, wherein:
a. the front plate comprises a front plate magnet;
b. the frame comprises a front ring and a back ring;
c. the front ring comprises ferromagnetic material;
d. the front plate magnet comprises ferromagnetic material with the opposite polarity to the filter magnet, whereby the front plate and filter are attracted to each other when placed within a predetermined distance from each other;
e. the back ring comprises a filter magnet;
f. the back plate comprises a back plate magnet, the back plate magnet having a polarity opposite the filter magnet, whereby the back plate and filter are attracted to each other when placed within a predetermined distance from each other.
